(19) United States
(12) Patent Application Publication
(10) Pub. No.: US 2006/0279537 A1
(43) Pub. Date: Dec. 14, 2006

(54) Method and apparatus for efficiently providing tactile information

(75) Inventors: Sang-youn Kim, Seoul (KR); Byung-seok Soh, Suwon-si (KR); Yong-beom Lee, Seoul (KR); Ki-uk Kyung, Gwangyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/452,388

(22) Filed: Jun. 14, 2006

(30) Foreign Application Priority Data
Jun. 14, 2005 (KR) 10-2005-0050946

(51) Int. Cl. G09G 5/00

(52) U.S. Cl. 345/156

(57) ABSTRACT

A method and apparatus for efficiently providing tactile information. The method includes receiving a position indicated by input means, determining whether the input means is in contact with an object using the position indicated by the input means and the position of the object, generating tactile information about movement of a tactile device from information about a texture of the object, when it is determined that the input means is in contact with the object, transforming the generated tactile information tactile information in a perception region that can be perceived by a user, transforming the tactile information in the perception region into a driving signal capable of driving the tactile device, and driving the tactile device according to the driving signal.

### CROSS-REFERENCE TO RELATED APPLICATION

This application claims priority from Korean Patent Application No. 10-2005-0050946 filed on Jun. 14, 2005 in the Korean Intellectual Property Office, the disclosure of which is incorporated herein by reference.

### BACKGROUND OF THE INVENTION

1. Field of the Invention

The present invention relates to a method and apparatus for efficiently providing tactile information, and more particularly, to a method and apparatus for efficiently providing tactile information, in which texture information about an object in a virtual space or in the real world is modulated tactile information in a perception region that can be perceived by humans and in which a frequency or a stroke size corresponding to the texture information about the object is modulated to provide lifelike texture information for the object.

2. Description of Related Art

In general, haptic technology can be divided into a field using kinesthetic information, a field using tactile information, and a field using thermal information.

Conventionally, the mainstream of haptic technology has been a technique for providing vibration to humans based on kinesthetic information, which is disclosed in various patent literature. For example, U.S. Pat. No. 6,278,439 discloses a method and apparatus for providing vibration based on force feedback. FIG. 1 is a conceptual view of an apparatus for providing vibration information based on force feedback.

A source wave 14 is initially provided. The source wave 14 defines a basic signal from which the effect is created. A control parameter step 16 adds a number of control parameters to the source wave 14 to define the wave. Control parameters include the frequency of the signal, its duration, its steady-state magnitude, and its offset. An impulse shaping step 18 modifies or shapes the signal to a desired “quality” to determine how the initial impulse force and the following steady state force will feel. The set of impulse parameters includes the impulse magnitude, the settle time, and the steady-state time. An application parameter step 20 adds application parameters describing how the shaped signal is applied to a force feedback interface device. A trigger parameter step 22 relates to trigger behavior and provides trigger parameters to the impulse-shaped signal. The trigger parameters are used to indicate, for example, when a defined effect should be executed.

However, the apparatus for providing vibration based on force feedback cannot be a tactile device because of being based on kinesthetic information instead of tactile information, and cannot provide the lifelike texture of an object.

### BRIEF SUMMARY

An aspect of the present invention provides a method and apparatus for providing tactile information, in which the texture of an object in a virtual space or in the real world is modulated tactile information in a perception region that can be clearly perceived by a human without pain.

An aspect of the present invention also provides a method and apparatus for providing tactile information, in which the frequency or displacement of tactile information is modulated to provide various types of tactile information.

An aspect of the present invention also provides a method and apparatus for providing tactile information, in which when a user is continuously stimulated with the same or similar types of stimuli, the user's tactile receptors are prevented from becoming dull by modulating the frequency of the stimulus.

According to an aspect of the present invention, there is provided a method for efficiently providing tactile information. The method includes receiving a position indicated by input means, determining whether the input means touches an object using the position indicated by the input means and the position of the object, generating tactile information about movement of a tactile device using information about the texture of the object when the input means is in contact with the object, transforming the generated tactile information tactile information in a perception region that can be perceived by a user, transforming the tactile information in the perception region into a driving signal capable of driving the tactile device, and driving the tactile device according to the driving signal.

According to another aspect of the present invention, there is provided a method for efficiently providing tactile information. The method includes receiving a position indicated by input means, determining whether the input means is in contact with an object using the position indicated by the input means and the position of the object, generating the size of a stroke of a tactile device from information about a texture of the object and generating the frequency of the tactile device by dividing the velocity of movement of the input unit on the object by the time required for movement of the input unit, when it is determined that the input means is in contact with the object, transforming the size of a stroke and the frequency of the tactile device into a driving signal capable of driving the tactile device, and driving the tactile device according to the driving signal.

According to still another aspect of the present invention, there is provided a method for efficiently providing tactile information. The method includes receiving a position indicated by input means, determining whether the input means is in contact with an object using the position indicated by the input means and the position of the object, generating tactile information about movement of a tactile device from information about the texture of the object if the input means is in contact with the object, modulating the frequency of the tactile information into a frequency having the same sensation level which stimulates a second tactile receptor if the tactile information stimulates a first tactile receptor for a predetermined amount of time, transforming the tactile information having the modulated frequency into a driving signal capable of driving the tactile device, and driving the tactile device according to the driving signal.

According to another aspect of the present invention, there is provided an apparatus for providing tactile information, the apparatus including: an input unit that receives an indicated position; a determining unit that determines whether the input unit is in contact with an object using the indicated position and a position of the object; a generating unit that generates tactile information about movement of a tactile device from information about a texture of the object, when the input unit is in contact with the object; a first transforming unit that transforms the generated tactile information into tactile information in a perception region that can be perceived by a user; a second transforming unit that transforms the tactile information in the perception region into a driving signal usable to drive the tactile device; and a drive unit that drives the tactile device according to the driving signal.

According to another aspect of the present invention, there is provided an apparatus for providing tactile information, the apparatus including: an input unit that receives an indicated position; a determining unit that determines whether the input unit is in contact with an object using the indicated position and a position of the object; a generating unit that generates a size of a stroke of a tactile device from information about a texture of the object and generates a frequency of the tactile device by dividing a velocity of movement of the input unit on the object by a time required for movement of the input unit, when the input unit is in contact with the object; a transforming unit that transforms the size of a stroke and the frequency of the tactile device into a driving signal usable to drive the tactile device; and a drive unit that drives the tactile device according to the driving signal.

According to another aspect of the present invention, there is provided an apparatus for providing tactile information, the apparatus including: an input unit that receives an indicated position; a determining unit that determines whether the input unit is in contact with an object using the indicated position and a position of the object; a generating unit that generates tactile information about movement of a tactile device from information about a texture of the object, when the input unit is in contact with the object; a modulating unit that modulates the frequency of the tactile information into a frequency having a same sensation level which stimulates a second tactile receptor when the tactile information stimulates a first tactile receptor for a predetermined amount of time; a transforming unit that transforms the tactile information having the modulated frequency into a driving signal usable to drive the tactile device; and a drive unit that drives the tactile device according to the driving signal.

According to another aspect of the present invention, there are provided computer-readable storage media encoded with processing instructions for causing a processor to execute the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a conceptual view of an apparatus for providing vibration information based on force feedback according to prior art;

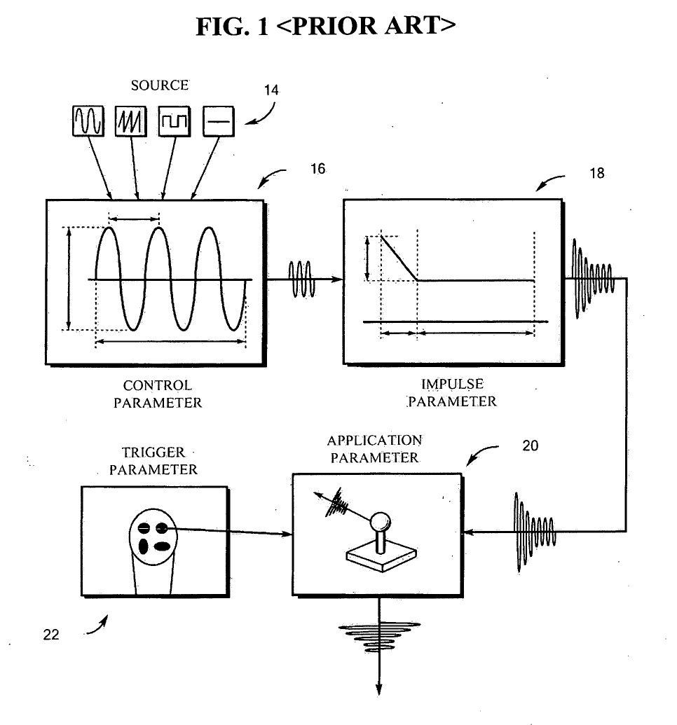

FIG. 2 illustrates a tactile information providing system according to an embodiment of the present invention;

FIG. 3 illustrates a principle used by the tactile information providing system of FIG. 2 to provide tactile information to a user through a contactor 50, according to an embodiment of the present invention;

FIG. 4 is a conceptual view of a process of transforming information about object tactile information in a perception region according to an embodiment of the present invention;

FIG. 5 is a view for explaining the process of FIG. 4 according to an embodiment of the present invention;

FIG. 6 is a conceptual view of a process of selectively stimulating human tactile receptors based on information about an object according to an embodiment of the present invention;

FIG. 7 is a view for explaining a process of preventing human tactile receptors from becoming dull according to an embodiment of the present invention;

FIG. 8 is a block diagram of an apparatus for providing tactile information according to an embodiment of the present invention;

FIG. 9 is a flowchart illustrating a process of transforming information about object tactile information in a perception region that can be perceived by a user, according to an embodiment of the present invention;

FIG. 10 is a flowchart illustrating a process of selectively stimulating human tactile receptors based on information about an object, according to an embodiment of the present invention; and

FIG. 11 is a flowchart illustrating a process of preventing human tactile receptors from becoming dull according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

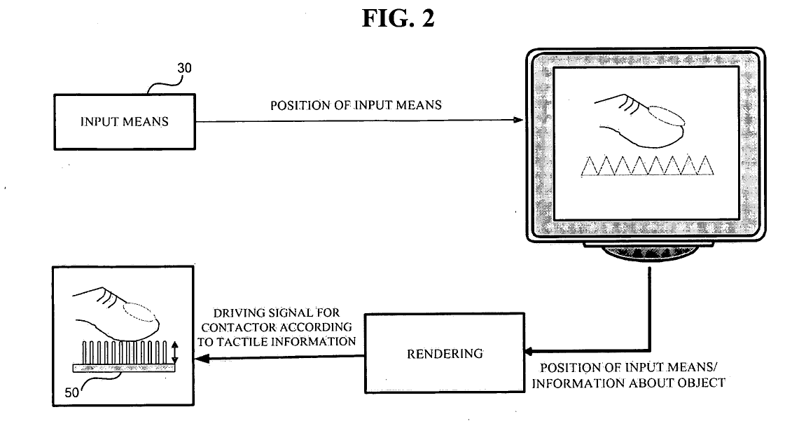

FIG. 2 illustrates a tactile information providing system according to an embodiment of the present invention.

When a user interacts with an object in a virtual world or the real world using input means 30 such as a mouse, an electric glove, a joystick, or a haptic device, a tactile information providing system according to an embodiment of the present invention generates tactile signals through rendering according to the position, shape, and texture of the object and transmits the tactile signals to a tactile device including a contactor 50, thereby providing tactile information to the user touching the tactile device.

Methods for providing tactile information using a tactile device can be divided into an active contact method or a passive contact method. In the following description, it is assumed that a user's hand remains in contact with a contactor of the tactile device such as a pin or a polymer, and tactile information is provided through movement of the contactor. In other words, it is assumed that the passive contact method is used. However, it is to be understood that embodiments of the present invention may employ the active contact method.

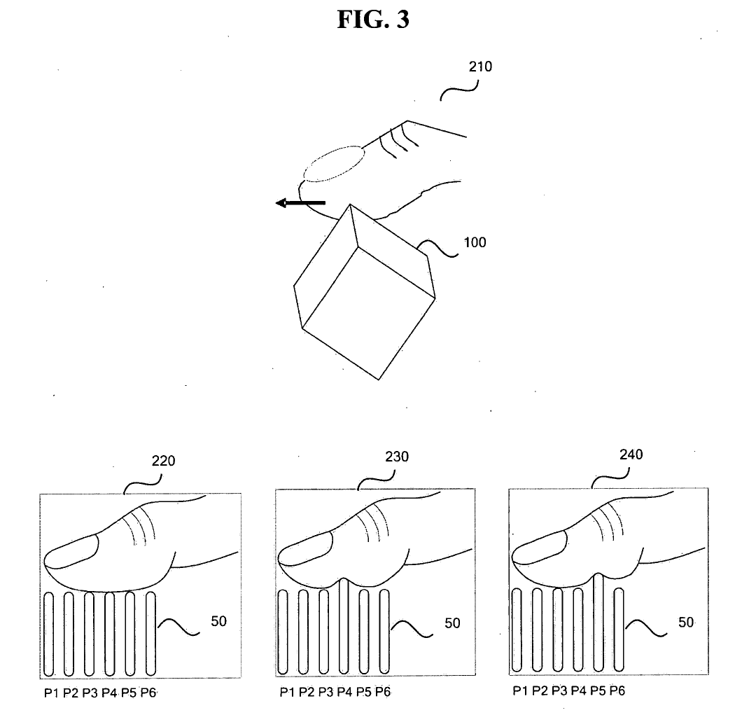

FIG. 3 illustrates a principle used by the tactile information providing system of FIG. 2 to provide tactile information to a user through a contactor 50, according to an embodiment of the present invention.

When a corner of an object 100 is scanned using input means having a tactile device attached thereto as in 210, a contactor 50 included in the tactile device raises a pin P4 as in 230 and then a pin P5 as in 240 to deliver the texture of the corner of the object. Further, just prior to the scanning, no pins are raised as in 220. The user can perceive the texture of the corner of the object touched with a fingertip, i.e., the roughness or smoothness of the surface of the corner, while the tactile device including the contactor 50 scans the object by moving the input means.

However, humans generally perceive a stimulus in a logarithmic fashion as the frequency of the stimulus increases, and perceive stimuli having the same magnitude as having different strengths if the stimuli have different frequencies. For example, when stimuli having the same magnitude are applied at 1 Hz and 250 Hz, humans perceive the stimuli as having different strengths. When a stimulus of 15 dB (um) is given at 1 Hz, humans cannot feel the stimulus. However, when a stimulus of 15 dB(um) is given at 250 Hz, humans can feel the stimulus well. When the size of a stroke of the contactor is too small, humans cannot perceive a stimulus. When the size of a stroke of the contactor is too large, humans may feel a stimulus as pain. A perception region varies with frequencies. Thus, there is a need for a method for transforming texture information about an object, input by scanning the object with input means having a tactile device attached thereto, tactile information in a perception region.

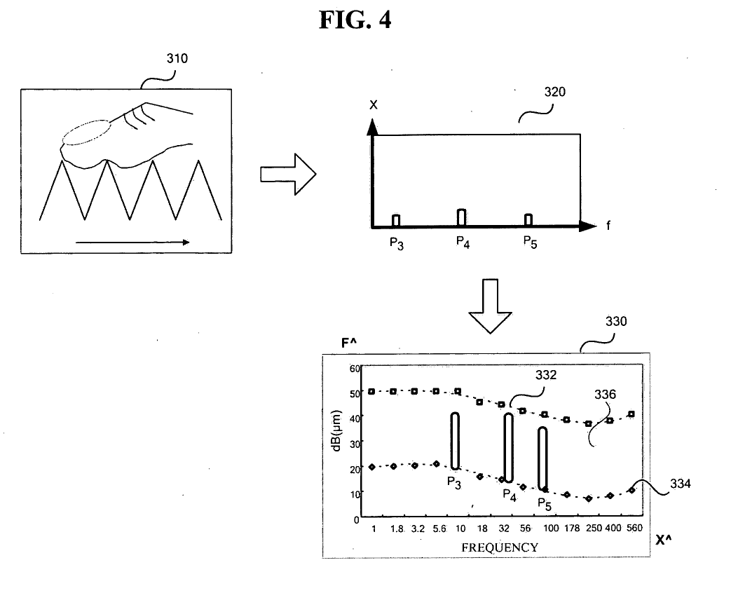

FIG. 4 is a conceptual view of a process of transforming information about object tactile information in a perception region according to an embodiment of the present invention.

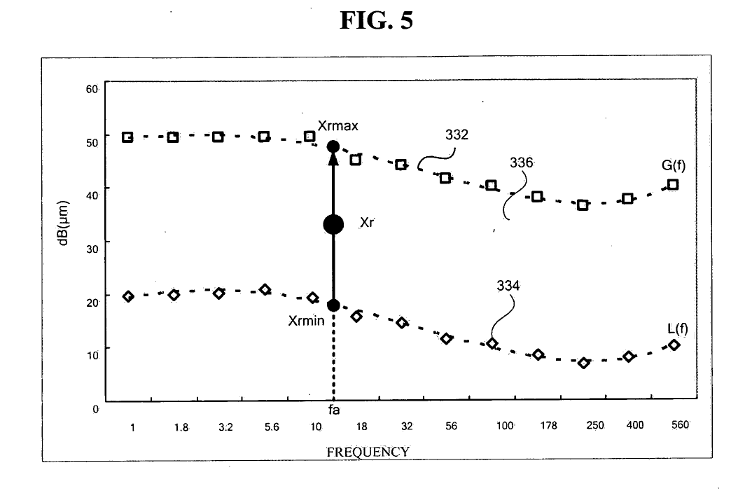

When a user scans an object as in 310, pins P3, P4, and P5 of the contactor 50 move according to the texture of the object such as the roughness or smoothness of the surface of the object or the stiffness of the object. Movement of the pins P3, P4, and P5 can be transformed into a frequency region as shown in 320. When the pins P3, P4, and P5 move at frequencies of 10 Hz, 50 Hz, and 100 Hz to make it seem as if they are being stroked, movement of the pins P3, P4, and P5 in the frequency region can be transformed into information in a perception region as shown in 330. A process of transforming movement of pins of a contactor, expressed in the frequency region, into information in the perception region will be described with reference to FIG. 5.

FIG. 5 is a view for explaining the process of FIG. 4 according to an embodiment of the present invention,

The frequency and the size of a stroke of each pin of FIG. 4 are modulated into those in the perception region. In the following description, only the pin P5 will be considered. It is assumed that the pin P5 vertically moves xμm fa times per second. In FIG. 5, for each frequency, the size of a stroke G(f) 332 that can be perceived by humans without pain and the size of a stroke L(f) 334 that cannot be perceived by humans are shown. In other words, humans perceive a stroke larger than G(f) as pain and cannot perceive a stroke smaller than L(f). G(f) and L(f) are experimentally obtained and can be expressed with fourth-degree equations of frequency as follows:
G(f)=1.4895f⁴−5.0357f³−0.9032f²+1.7281f+50.028 (1); and
L(f)=0.0022f⁴−0.016f³−0.3971f²+2.4068f+17.375 (2).

However, Equations 1 and 2 are only experimentally obtained examples of G(f) and L(f). However, it is to be understood that various other coefficients and constants of a frequency f other than those in Equations 1 and 2 may be used.

A linear transform method for transforming the stroke of the pin P5 into a stroke in a perception region 336 where humans can perceive the stroke without pain can be expressed as follows:

$${x}_{r} = \frac{x}{{x}_{rmax}} ( {10}^{\frac{G ( f )}{20}} - {10}^{\frac{L ( f )}{20}} ) + {10}^{\frac{L ( f )}{20}} , \qquad ( 3 )$$

where G(f) and L(f) are expressed by Equations 1 and 2, G(f) indicates a threshold in which humans can feel comfortable without pain, and L(f) indicates a threshold in which humans can feel nothing. At this time, L(f) may be set to 0. X indicates the size of a stroke corresponding to the displacement of the surface of a scanned object, Xₘₐₓ indicates the maximum allowable size of a stroke of the pin P5, and Xᵣ indicates the size of a stroke of the pin P5 transformed into a perception region.

Equation 3 expresses the linear transform method using G(f) and L(f).

A method for transforming the size of a stroke of a pin into the size of a stroke in a perception region may include a non-linear transform method as well as the linear transform method.

Using Equations 1, 2, and 3, it can be determined whether the output of the contactor can be perceived by humans without pain. For example, in the case of a contact moving xμm at a frequency of fa, its output may generate a stroke in a perception region that can be clearly perceived without pain if L(fa)<20log X<G(fa) is satisfied. On the other hand, if 20log x>G(f), the stroke of the contactor causes pain to humans.

To provide lifelike texture information, human tactile receptors should be simultaneously or selectively stimulated according to various textures of objects. Human tactile receptors can be classified into four types. A first receptor (SA I type: Merkel's disk) feels a corner and a pressure and can feel a stimulus at a frequency of 0.4-3 Hz and most clearly at a frequency of 0.4-1 Hz. A second receptor (SA II type: Ruffini ending) feels stretchablility of the skin and can feel a stimulus at a frequency of 80-500 Hz and most clearly at a frequency of 150-400 Hz. A third receptor (RA I type: Meissner Corpuscles) feels the roughness of a rough surface and speed and can feel a stimulus at a frequency of 3-100 Hz and most clearly at a frequency of 25-40 Hz. A fourth receptor (RA II type: Pacinian Corpuscles) feels an acceleration and vibration of a smooth surface and can feel a stimulus at a frequency of 35-500 Hz and most clearly at a frequency of 250-300 Hz. As such, the tactile receptors perceive various tactile sensations by feeling frequencies in different ranges.

The principle described above, in which contactors of a tactile device are actuated at frequencies that can be perceived by human tactile receptors according to the texture of the surface of a scanned object, can be used to provide lifelike texture information to users, resulting in a sensation like that of actually touching the object.

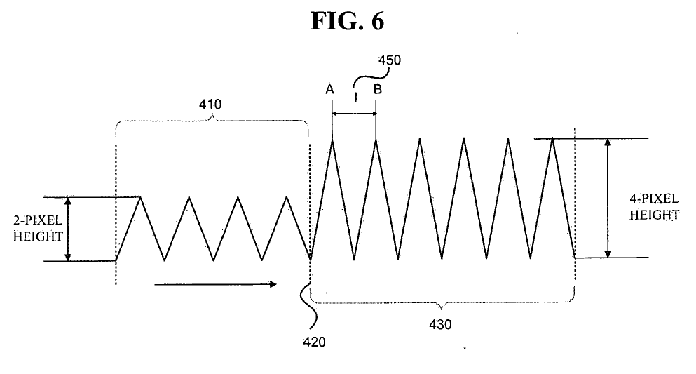

FIG. 6 is a conceptual view of a process of selectively stimulating human tactile receptors based on information about an object according to an embodiment of the present invention. In FIG. 6, the surfaces of scanned objects are exaggerated and an object 410 having a low height and a rough surface and then an object 430 having a high height and a smooth surface are scanned. When a contact moves from a point A to a point B of an object, the frequency F of the contact can be calculated as follows:
F=v/l (4),
where v indicates a velocity read from a velocity sensor in a case where the velocity sensor is attached to the tactile device and v can be calculated as v=l/t in a case where the velocity sensor is not included in the tactile device. t indicates the time required for movement from A to B, and I indicates a distance from A to B.

When the object 410 is scanned, the contactor of the tactile device generates a stroke at a predetermined frequency. At a boundary 420 between the object 410 and the object 430, the contactor generates a stroke at a frequency corresponding to a corner. When the object 430 is scanned, the contactor generates a stroke at a frequency higher than the frequency for the object 410. As a result, a user feels like he/she is touching something smoother than when the object 410 is scanned. The user has a sensation like that of touching a corner in response to a stroke at 0 Hz, a rough surface in response to a stroke at 18 Hz or higher, and a smooth surface in response to a stroke at 178 Hz or higher.

By changing frequency in real time according to the texture of a scanned object, tactile receptors can be simultaneously or selectively stimulated.

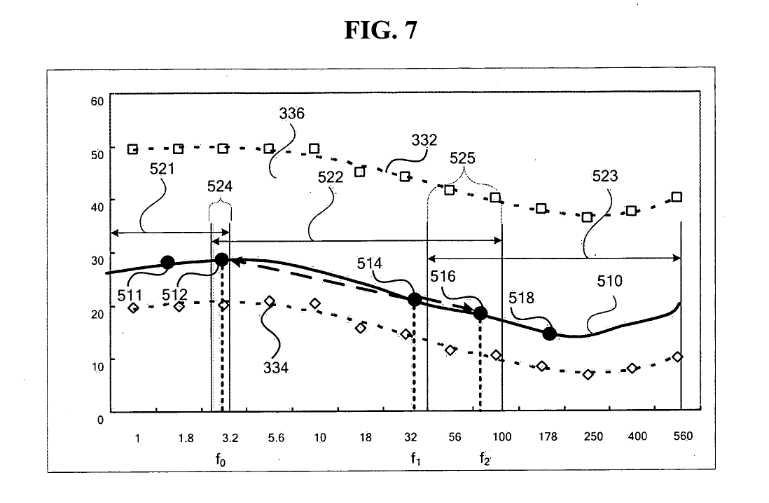

However, when humans are exposed to a stimulus of the same level for a predetermined amount of time, human senses are likely to become dull. A process of preventing human tactile receptors from becoming dull will be described with reference to FIG. 7.

As mentioned above, humans have different types of touch sensations according to which of the four tactile receptors is stimulated. Human tactile receptors become dull when exposed to the same stimulus for a predetermined amount of time. To prevent human tactile receptors from becoming dull, a dull tactile receptor is activated by stimulating another tactile receptor with a stimulus having another frequency with the same sensation level. The four tactile receptors react to different frequency regions. For example, the first receptor reacts to a frequency region 521, the third receptor reacts to a frequency region 522, and the fourth receptor reacts to a frequency region 523. The frequency regions to which the receptors react may overlap. For example, the first receptor and the third receptor both react to a frequency region 524 around about 3 Hz and the fourth receptor and the fourth receptor react to a frequency region 525 around 35-100 Hz.

When humans scan a rough object for 2 minutes or more, the third receptor becomes dull. To stimulate another receptor to a rough feeling, modulation can be made into frequencies 512 and 516 of the overlapping frequency regions 524 and 525 while maintaining the same sensation level S(f) 510. However, since the third receptor can be activated by stimulating any other tactile receptor, modulation can be made into a frequency of a frequency region of any other tactile receptor, e.g., a frequency 511 of the frequency region 521 of the first receptor or a frequency 518 of the frequency region 523 of the fourth receptor, without being limited to frequencies of overlapping frequency regions. For example, it is assumed that a user scans the rough surface of an object and a contactor vibrates at a frequency f1 514 of about 30 Hz to provide a sense of roughness. If the contactor vibrates at about 30 Hz for 2 minutes or more, a user's third receptor becomes dull and cannot feel a sense of touching the rough surface any more. At this time, the frequency of the contactor is modulated into a frequency f2 516 of 80 Hz that simulates both the third receptor and the fourth receptor, and the size of a stroke of the contactor is modulated into a value 516 that is smaller than that of a stroke at 30 Hz to maintain a sensation level 510 that provides a similar feeling as the size of a stroke at 30 Hz. Once the sense of the third receptor is activated by frequency and stroke size modulation, movement of the contactor returns to the original frequency and the original stroke size 514.

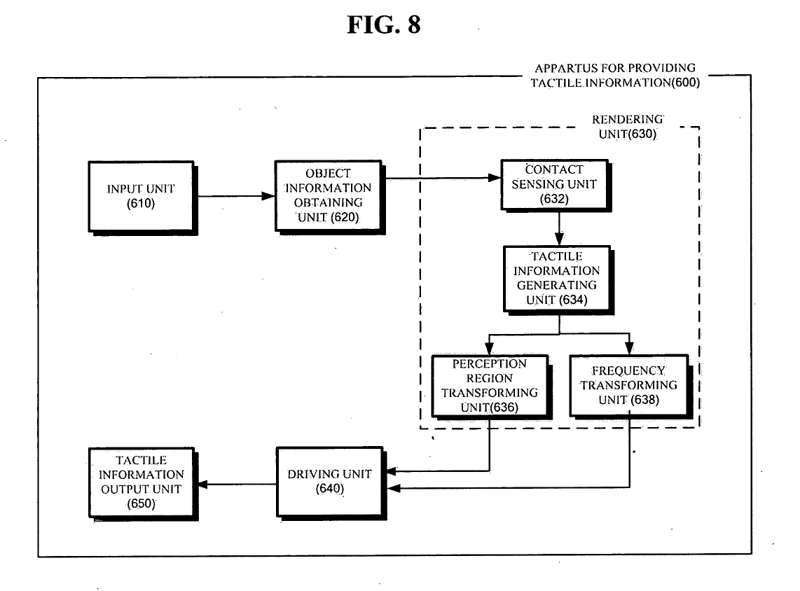

FIG. 8 is a block diagram of an apparatus for providing tactile information according to an embodiment of the present invention.

An apparatus 600 for providing tactile information includes an input unit 610, an object information obtaining unit 620, a rendering unit 630, a driving unit 640, and a tactile information output unit 650. Optionally, as shown in FIG. 6, the rendering unit 630 includes a contact sensing unit 632, a tactile information generating unit 634, a perception region transforming unit 636, and a frequency transforming unit 638.

The input unit 610 is input means such as a mouse or a haptic device and provides a position to the object information obtaining unit 620. The input unit 610 can be any type of input means such as a mouse, a haptic device (including a tactile device), a joystick, a keyboard, and a touch pad. The input unit 610 and the tactile information output unit 650 are separated in an embodiment of the present invention, however the tactile information output unit 650 may be mounted in the input unit 610, for example, a tactile device may be attached to a mouse.

The object information obtaining unit 620 generates physical information about a scanned object, e.g., information such as the position, shape, and stiffness of an object and a difference between heights of two objects, or accesses and obtains previously generated information about an object. Texture information includes the roughness or smoothness of the surface of an object or information about whether a corresponding portion is a corner of the object.

The rendering unit 630 checks if the input unit 610 is in contact with an object and transforms texture information about the object into tactile information to be provided to a user through a tactile device. The rendering unit 630 according to an embodiment of the present invention checks if the input unit 610 is in contact with an object using the position indicated by the input unit 610 and position information about the object provided from the object information obtaining unit 620. The contact sensing unit 632 of the rendering unit 630 performs such a check using a conventional check method, e.g., an algorithm using a bounding box. A contact check algorithm using a bounding box includes axis-aligned bounding boxes (AABBs), oriented bounding box (OBB), and k-DOPs.

The tactile information generating unit 634 transforms texture information about an object into tactile information that can deliver a sense of touch to a user, e.g., the size of a stroke or the frequency of a contactor by driving the tactile information output unit 650.

The perception region transforming unit 636 transforms texture information about an object tactile information in a perception region using a transform method as expressed by Equation 3. For example, the perception region transforming unit 636 transforms the size X of a stroke corresponding to displacement of the object into the size Xr of a stroke in a perception region between L(f) and G(f).

The frequency transforming unit 638 calculates a frequency at which each contactor of the tactile information output unit 650 is to be driven from the texture of the scanned object and the velocity of movement from one point to another point of the object as described with reference to FIG. 6. As described with reference to FIG. 7, the frequency transforming unit 638 transforms a frequency into overlapping frequency regions that can stimulate another tactile receptor at the same sensation level and transforms the transformed frequency back into the original frequency when the same or similar types of stimulus are continuously provided for a predetermined amount of time.

The driving unit 640 transforms tactile information provided from the rendering unit 630 into a driving signal capable of driving the tactile information output unit 650 and transmits the driving signal to the tactile information output unit 650. The driving signal may be a voltage or a heat.

The tactile information output unit 650 conveys the texture of a scanned object to a user by driving contactors according to the driving signal from the driving unit 640. The tactile information output unit 680 may be a tactile device and may include contactors that contact a user's skin and directly provide tactile information.

In FIGS. 6 through 8, various components mean, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to execute on one or more processors. The functionality provided for in the components and modules may be combined into fewer components and modules or further separated into additional components and modules. In addition, components and units may be implemented such that they play one or more central processing units (CPUs) in a device or a secure MMC.

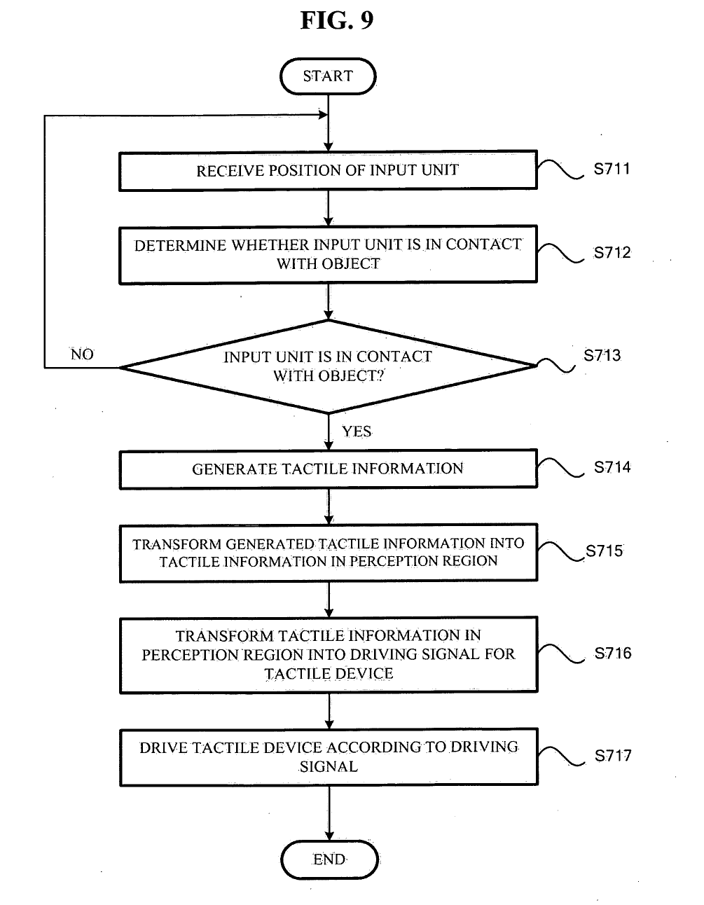

FIG. 9 is a flowchart illustrating a process of transforming information about object tactile information in a perception region that can be perceived by a user, according to an embodiment of the present invention. This process is explained with reference to the apparatus of FIG. 8 for ease of explanation only.

Referring to FIGS. 8 and 9, the position of the input unit 610 is input to the apparatus 600 according to an embodiment of the present invention in operation S711. It is determined whether the input unit 610 is in contact with an object using the position of the input unit 610 and position information about the object in operation S712. If the input unit 610 is in contact with the object in operation S713, the tactile information generating unit 634 generates tactile information from texture information about the object scanned by the input unit 610 in operation S714. If the input unit 6120 is not in contact with the object in operation 713, the process returns to operation S711. The perception region transforming unit 636 transforms the generated tactile information into tactile information in a perception region that can be perceived by humans in operation S715. The tactile information in the perception region is transformed by the driving unit 640 into a driving signal usable to drive the tactile information output unit 650 in operation S716 and is provided as lifelike tactile information to the user through the tactile information output unit 650 in operation S717.

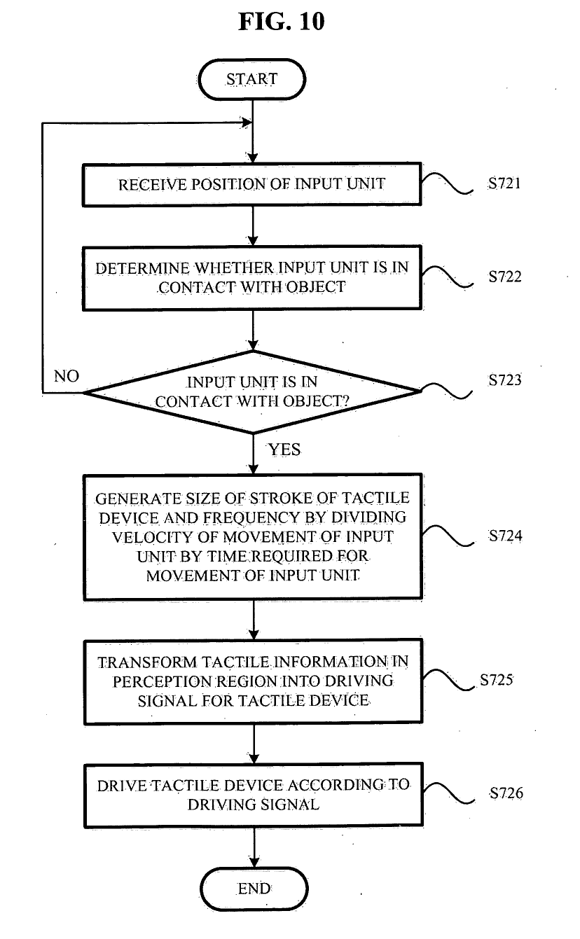

FIG. 10 is a flowchart illustrating a process of selectively stimulating human tactile receptors based on information about an object, according to an embodiment of the present invention. This process is explained with reference to the apparatus of FIG. 8 for ease of explanation only.

The position of the input unit 610 is input to the apparatus 600 according to an embodiment of the present invention in operation S721. It is determined whether the input unit 610 is in contact with an object using the position of the input unit 610 and position information about the object in operation S722. If the input unit 610 is in contact with the object in operation S723, the tactile information generating unit 634 generates tactile information from texture information about the object scanned by the input unit 610 in step S724. If the input unit 610 is not in contact with the object in operation S723, the process returns to operation S721. The tactile information includes the displacement and frequency of a tactile device and the frequency can be calculated by dividing the velocity of movement of the input unit 610 on the object by the time required for movement of the input unit 610. The tactile information is transformed by the driving unit 640 into a driving signal usable to drive the tactile information output unit 650 in operation S725 and is provided as lifelike tactile information to the user through the tactile information output unit 650 in operation S726.

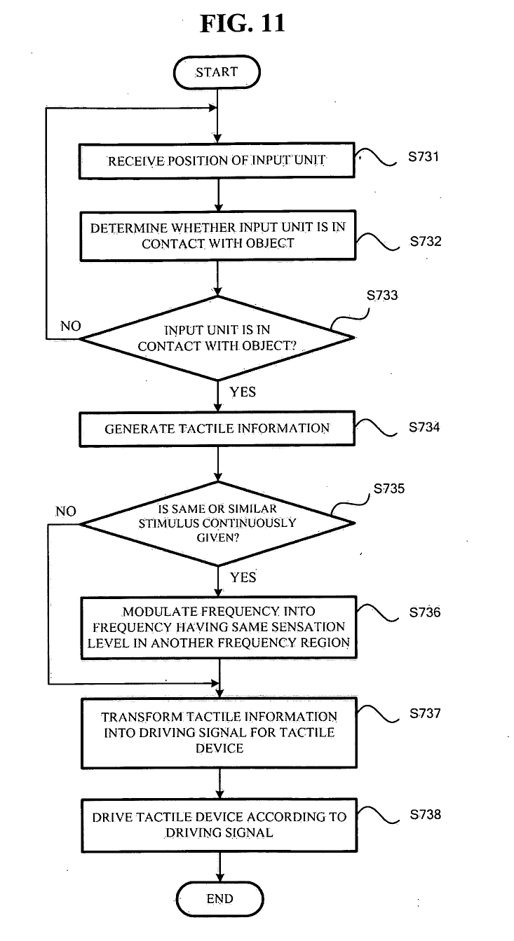

FIG. 11 is a flowchart illustrating a process of preventing human tactile receptors from becoming dull according to an embodiment of the present invention. This process is explained with reference to the apparatus of FIG. 8 for ease of explanation only.

The position of the input unit 610 is input to the apparatus 600 according to an embodiment of the present invention in operation S731. It is determined whether the input unit 610 is in contact with an object using the position of the input unit 610 and position information about the object in operation S732. If the input unit 610 is in contact with the object in operation S733, the tactile information generating unit 634 generates tactile information from texture information about the object scanned by the input unit 610 in operation S734. If the input unit 610 is not in contact with the object in operation S733, the process returns to operation S731. The frequency transforming unit 638 determines whether the same or similar types of stimuli are continuously provided for a predetermined amount of time in operation S735. If the same or similar types of stimuli are continuously provided for a predetermined amount of time in operation S735, a current frequency is transformed into frequencies in overlapping frequency regions which stimulate another tactile receptor and have the same sensation level and the transformed frequencies are transformed back into the original frequency in operation S736. If the same or similar types of stimuli are not continuously provided for a predetermined amount of time in operation S735, the process continues to operation S736. The tactile information provided by the rendering unit 630 is transformed by the driving unit 640 into a signal usable to drive the tactile information output unit 650 in operation S737 and is provided as lifelike tactile information to a user through the tactile information output unit 650.

The methods and apparatuses for efficiently providing tactile information according to the above-described embodiments of the present invention provide at least the following advantages.

First, clearer and lifelike tactile information can be provided by transforming texture information about an object in a virtual space or in the real world into texture information in a domain that can be clearly perceived by humans without pain.

Second, various human tactile receptors are stimulated by transforming a frequency or a stroke of tactile information, thereby providing lifelike tactile information.

Third, when the same or similar type of stimulus, is continuously provided for a predetermined amount of time, its frequency is transformed, thereby preventing human tactile receptors from becoming dull.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of providing tactile information, the method comprising:
receiving a position indicated by an input unit;
determining whether the input unit is in contact with an object using the position indicated by the input unit and a position of the object;
generating tactile information about movement of a tactile device from information about a texture of the object, when the input unit is in contact with the object;
transforming the generated tactile information into tactile information in a perception region that can be perceived by a user;
transforming the tactile information in the perception region into a driving signal usable to drive the tactile device; and
driving the tactile device according to the driving signal.

2. The method of claim 1, wherein the tactile information about movement of the tactile device includes a size of a stroke and a frequency of the tactile device.

3. The method of claim 2, wherein the transforming the tactile information in the perception region comprises transforming the size of a stroke of the tactile device into a size Xr of a stroke in the perception region using the following equation:
$${x}_{r} = \frac{x}{{x}_{rmax}} ( {10}^{\frac{G ( f )}{20}} - {10}^{\frac{L ( f )}{20}} ) + {10}^{\frac{L ( f )}{20}} , and$$
wherein G(f) is a function indicating a maximum stroke size of the tactile device that the user can feel without pain at a frequency of f, L(f) is a function indicating a minimum stroke size of the tactile device that the user can feel at a frequency of f, X indicates a size of a stroke corresponding to the displacement of the surface of the object, and Xₘₐₓ indicates a maximum allowable size of the stroke in the perception region at a frequency of f.

4. The method of claim 1, wherein the perception region has a stroke that is smaller than a level causing pain to the user and is larger than a level causing no feeling to the user.

5. The method of claim 4, wherein the level causing pain to the user is calculated using a polynomial for a frequency of the tactile device.

6. The method of claim 4, wherein the level causing pain to the user is calculated using the following equation:
G(f)=af⁴+bf³+cf²+df¹+e, and
wherein a, b, c, d, and e are constants and f is the frequency of the tactile device.

7. The method of claim 4, wherein the level causing pain to the user is calculated using the following equation:
G(f)=1.4895f⁴−5.0357f³−0.9032f²+1.7281f+50.028, and
wherein f is the frequency of the tactile device.

8. The method of claim 4, wherein the level causing no feeling to the user is calculated using a polynomial for the frequency of the tactile device.

9. The method of claim 4, wherein the level causing no feeling to the user is calculated using the following equation:
L(f)=af⁴+bf³+cf²+df¹+e, and
wherein a, b, c, d, and e are constants and f is the frequency of the tactile device.

10. The method of claim 4, wherein the level causing no feeling to the user is calculated using the following equation:
L(f)=0.0022f⁴−0.016f³−0.3971f²+2.4068f+17.375, and
wherein f is the frequency of the tactile device.

11. The method of claim 1, wherein the generating tactile information comprises generating a size of a stroke of the tactile device from the information about the texture of the object and generating a frequency of the tactile device by dividing a velocity of movement of the input unit on the object by a time required for movement of the input unit.

12. The method of claim 1, further comprising modulating a frequency of the tactile information in the perception region into a frequency having a same sensation level that stimulates a second tactile receptor when the tactile information in the perception region stimulates a first tactile receptor for a predetermined amount of time, wherein the tactile information transformed into the driving signal usable to drive the tactile device has the modulated frequency.

13. A method of providing tactile information, the method comprising:
receiving a position indicated by an input unit;
determining whether the input unit is in contact with an object using the position indicated by the input unit and a position of the object;
generating a size of a stroke of a tactile device from information about a texture of the object and generating a frequency of the tactile device by dividing a velocity of movement of the input unit on the object by a time required for movement of the input unit, when the input unit is in contact with the object;
transforming a size of a stroke and the frequency of the tactile device into a driving signal usable to drive the tactile device; and
driving the tactile device according to the driving signal.

14. The method of claim 13, further comprising modulating the frequency of the tactile device into a frequency that can be perceived by a tactile receptor stimulated by the texture of the object.

15. The method of claim 13, further comprising transforming the tactile information into tactile information in a perception region that can be perceived by the user, wherein the tactile information transformed into the driving signal is tactile information transformed in the perception region.

16. The method of claim 15, wherein the transforming the tactile information in a perception region comprises transforming the size of a stroke of the tactile device into a size Xr of a stroke in the perception region using the following equation:
$${x}_{r} = \frac{x}{{x}_{rmax}} ( {10}^{\frac{G ( f )}{20}} - {10}^{\frac{L ( f )}{20}} ) + {10}^{\frac{L ( f )}{20}} , and$$
wherein G(f) is a function indicating a maximum stroke size of the tactile device that the user can feel without pain at a frequency of f, L(f) is a function indicating a minimum stroke size of the tactile device that the user can feel at a frequency of f, X indicates the size of a stroke corresponding to a displacement of the surface of the object, and Xₘₐₓ indicates a maximum allowable size of the stroke in the perception region at a frequency of f.

17. The method of claim 15, wherein the perception region has a stroke that is smaller than a level causing pain to the user and is larger than a level causing no feeling to the user.

18. A method of providing tactile information, the method comprising:
receiving a position indicated by an input unit;
determining whether the input unit is in contact with an object using the position indicated by the input unit and a position of the object;
generating tactile information about movement of a tactile device from information about a texture of the object when the input unit is in contact with the object;
modulating a frequency of the tactile information into a frequency having a same sensation level which stimulates a second tactile receptor when the tactile information stimulates a first tactile receptor for a predetermined amount of time;
transforming the tactile information having the modulated frequency into a driving signal usable to drive the tactile device; and
driving the tactile device according to the driving signal.

19. The method of claim 18, further comprising:
demodulating the modulated frequency into the original frequency;
transforming tactile information having the demodulated frequency into a driving signal usable to drive the tactile device; and
driving the tactile device according to the driving signal.

20. The method of claim 18, wherein the tactile information about movement of the tactile device includes a size of a stroke and a frequency of the tactile device.

21. The method of claim 18, further comprising transforming the tactile information into tactile information in a perception region that can be perceived by the user, wherein the tactile information transformed into the driving signal is tactile information transformed in the perception region.

22. The method of claim 21, wherein the transforming the tactile information in a perception region comprises transforming a size of a stroke of the tactile device into a size Xr of a stroke in the perception region using the following equation:
$${x}_{r} = \frac{x}{{x}_{rmax}} ( {10}^{\frac{G ( f )}{20}} - {10}^{\frac{L ( f )}{20}} ) + {10}^{\frac{L ( f )}{20}} , and$$
wherein G(f) is a function indicating a maximum stroke size of the tactile device that the user can feel without pain at a frequency of f, L(f) is a function indicating a minimum stroke size of the tactile device that the user can feel at a frequency of f, X indicates a size of a stroke corresponding to the displacement of the surface of the object, and Xₘₐₓ indicates a maximum allowable size of the stroke in the perception region at a frequency of f.

23. The method of claim 21, wherein the perception region has a stroke that is smaller than a level causing pain to the user and is larger than a level causing no feeling to the user.

24. An apparatus for providing tactile information, the apparatus comprising:
an input unit that receives an indicated position;
a determining unit that determines whether the input unit is in contact with an object using the indicated position and a position of the object;
a generating unit that generates tactile information about movement of a tactile device from information about a texture of the object, when the input unit is in contact with the object;
a first transforming unit that transforms the generated tactile information into tactile information in a perception region that can be perceived by a user;
a second transforming unit that transforms the tactile information in the perception region into a driving signal usable to drive the tactile device; and
a drive unit that drives the tactile device according to the driving signal.

25. The apparatus of claim 24, wherein the tactile information about movement of the tactile device includes a size of a stroke and a frequency of the tactile device.

26. The apparatus of claim 24, wherein the perception region has a stroke that is smaller than a level causing pain to the user and is larger than a level causing no feeling to the user.

27. An apparatus for providing tactile information, the apparatus comprising:
an input unit that receives an indicated position;
a determining unit that determines whether the input unit is in contact with an object using the indicated position and a position of the object;
a generating unit that generates a size of a stroke of a tactile device from information about a texture of the object and generates a frequency of the tactile device by dividing a velocity of movement of the input unit on the object by a time required for movement of the input unit, when the input unit is in contact with the object;
a transforming unit that transforms the size of a stroke and the frequency of the tactile device into a driving signal usable to drive the tactile device; and
a drive unit that drives the tactile device according to the driving signal.

28. The apparatus of claim 27, comprising a modulating unit that modulates the frequency of the tactile device into a frequency that can be perceived by a tactile receptor stimulated by the texture of the object.

29. The apparatus of claim 27, further comprising a second transforming unit that transforms the tactile information into tactile information in a perception region that can be perceived by the user, wherein the tactile information transformed into the driving signal is tactile information transformed in the perception region.

30. An apparatus for providing tactile information, the apparatus comprising:
an input unit that receives an indicated position;
a determining unit that determines whether the input unit is in contact with an object using the indicated position and a position of the object;
a generating unit that generates tactile information about movement of a tactile device from information about a texture of the object, when the input unit is in contact with the object;
a modulating unit that modulates the frequency of the tactile information into a frequency having a same sensation level which stimulates a second tactile receptor when the tactile information stimulates a first tactile receptor for a predetermined amount of time;
a transforming unit that transforms the tactile information having the modulated frequency into a driving signal usable to drive the tactile device; and
a drive unit that drives the tactile device according to the driving signal.

31. The apparatus of claim 30, further comprising:
a demodulating unit that demodulates the modulated frequency into the original frequency; and
a second transforming unit that transforms tactile information having the demodulated frequency into a driving signal usable to drive the tactile device.

32. The apparatus of claim 30, wherein the tactile information about movement of the tactile device includes a size of a stroke and a frequency of the tactile device.

33. The apparatus of claim 30, further comprising a third transforming unit that transforms the tactile information into tactile information in a perception region that can be perceived by the user, wherein the tactile information transformed into the driving signal is tactile information transformed in the perception region.

34. A computer-readable storage medium encoded with processing instructions for causing a processor to execute a method of claim 1.

35. A computer-readable storage medium encoded with processing instructions for causing a processor to execute a method of claim 13.

36. A computer-readable storage medium encoded with processing instructions for causing a processor to execute a method of claim 18.
